(19) United States
(12) Patent Application Publication
(10) Pub. No.: US 2024/0104510 A1
(43) Pub. Date: Mar. 28, 2024

(54) REDUCED USER AVAILABILITY

(71) Applicant: Microsoft Technology Licensing, LLC, Redmond, WA (US)

(72) Inventors: Nir NETES, Asker (NO); Knut Harald RYAGER, Oslo (NO); Mohammdreza BONYADI, Trondheim (NO); Håkon Bergland BRUGÅRD, TromsØ (NO); Espen SOMMERFELT, Osol (NO); Tinus Sola FLAGSTAD, Oslo (NO); Malgorzata PARUCH, Sola (NO); Violet Wangui MWANGI, Nairobi (KE); Erlend FISKERUD, TromsØ (NO)

(73) Assignee: Microsoft Technology Licensing, LLC, Redmond, WA (US)

(21) Appl. No.: 17/934,689

(22) Filed: Sep. 23, 2022

(51) Int. Cl. G06Q 10/10

(52) U.S. Cl. CPC G06Q 10/1093

(57) ABSTRACT

Systems and methods for inferring and notifying an end user about reduced availability of a target user or group of target users in a time range of interest. For instance, the reduced availability service includes components for collecting calendar event information and calendar settings information corresponding to a calendar of a target user, generating an interval graph data structure based on the collected calendar information, determining working hours for the target user, identifying periods of time where reduced availability is determined in the target user's calendar, and generating a notification of the target user's reduced availability for alerting the end user.

### BACKGROUND

In a typical work environment, colleagues use calendar services to manage appointments and events, organize meetings, view group schedules, and other scheduling tasks. Due to a variety of reasons, there may be periods of time when a user's colleagues have reduced availability in their schedules for work-related projects or tasks. Currently, there is a need of predicting or inferring reduced availability in advance and accordingly alerting a user about upcoming periods where the user's colleagues would be working with reduced availability.

It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods for inferring and notifying about reduced availability of a user a group of users. Examples of the present disclosure efficiently infer and notify about reduced availability of the user or group in upcoming periods by simulating calendaring constraints in real-time using an interval graph data structure (e.g., an interval tree). When reduced availability for a target user is determined, the systems and methods described herein alert an end user (e.g., a colleague of the target user) about the target user's reduced availability. Thus, the end user can be alerted ahead of time (e.g., of the reduced availability), which allows for the end user to prepare or otherwise respond to the target user's upcoming reduced availability.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system for inferring and notifying about reduced availability of a user a group of users according to an example;

FIG. 2 is a block diagram of components of a reduced availability service according to an example;

FIG. 3 is an illustration of an interval graph data structure according to an example;

FIG. 4 is an illustration of example notification messages;

FIG. 5 is a flowchart depicting operations of an example method for inferring and notifying about reduced availability of a user a group of users;

FIG. 6 is a block diagram illustrating example physical components of a computing device with which aspects of the disclosure may be practiced; and

FIGS. 7A and 7B are block diagrams of an example mobile computing device with which aspects of the present disclosure may be practiced.

### DETAILED DESCRIPTION

A need exists for a tool that enables a user to keep on top of who (e.g., amongst the user's colleagues, teammates, organization social network contacts) is going to be working with reduced availability soon. For example, when working in a collaborative work environment, groups of colleagues work together to accomplish work tasks. When a colleague is going to be working with reduced availability, it can be useful for others in the group to know ahead of time to allow the others to prepare in anticipation of target user's upcoming reduced availability.

Examples described in this disclosure relate to systems and methods for inferring and notifying about reduced availability of a user or a group of users according to an example. The present disclosure provides a plurality of technical features including: a reduced availability service that infers and alerts users in advance about reduced availability of colleagues (target users) in upcoming periods; a calendar information collector that requests or otherwise receives various calendar information (e.g., calendar settings and event information and metadata) of each target user; an reduced availability detector that, based on the received information, determines periods of time in which target users are working with reduced availability in their schedules. According to examples, an event overlap detector utilizes an interval graph data structure to simulate calendaring constraints in real-time by determining and overlaying a target user's working hours, calendar events, and calendar settings into the interval graph data structure. The interval graph data structure allows for scanning through vast amounts of data in memory efficiently, for example, with minimal runtime cost. Thus, less memory space is required, processor load is reduced, and processing speed is increased, among other benefits.

The overlaps are analysed against a threshold to calculate an amount of availability the target user may have in a time period of interest, and thus, whether the target user will be working with reduced availability. In examples, the identified overlaps are provided to a notification generator for providing a notification with a message alerting an end user about an upcoming period where the end user's colleague or a group of colleagues are working with reduced availability, among other examples.

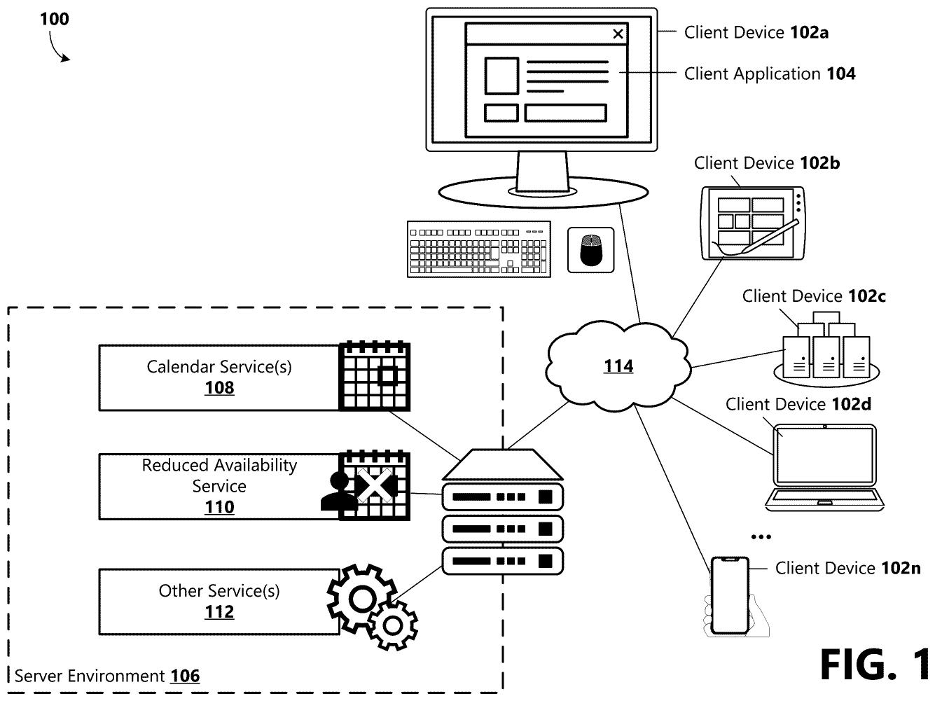

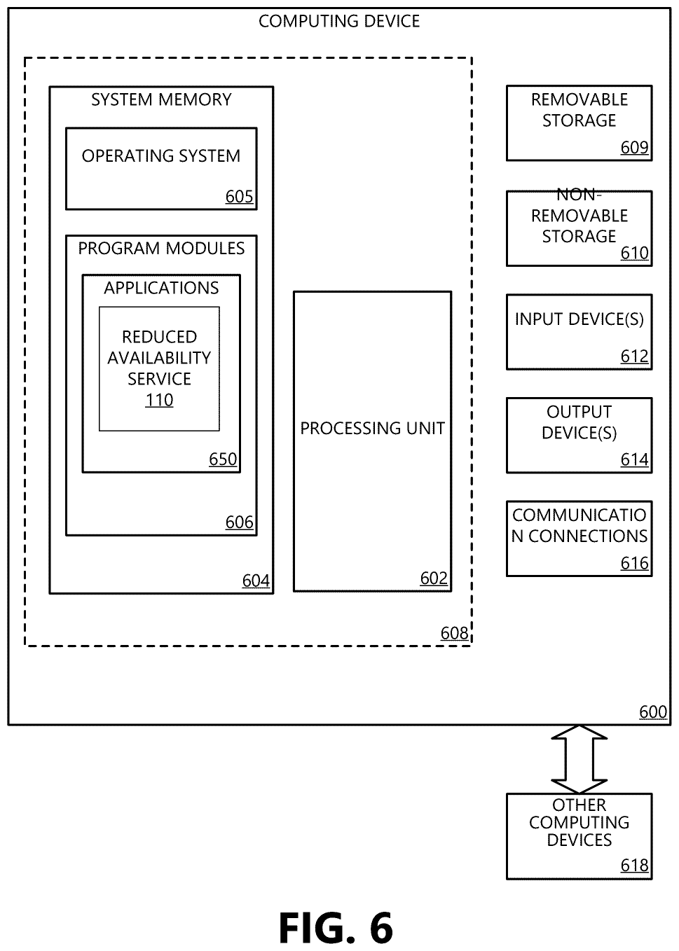

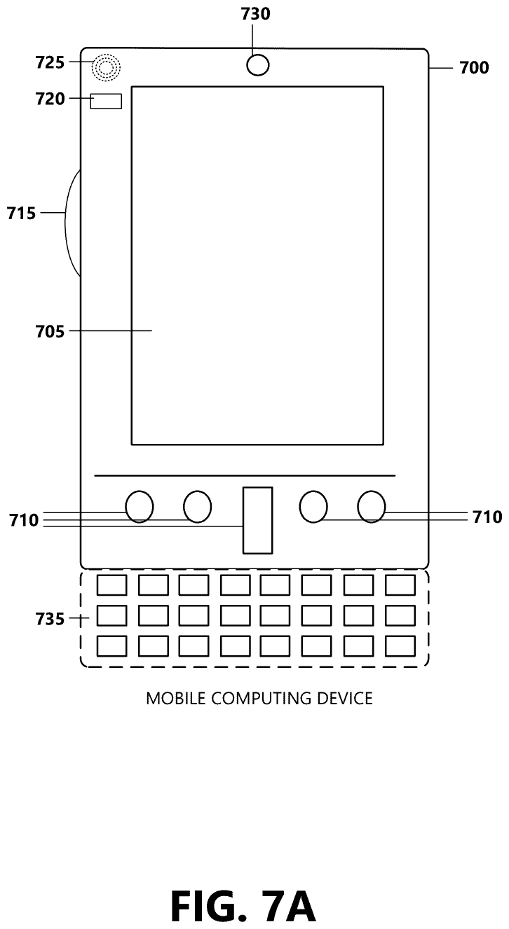

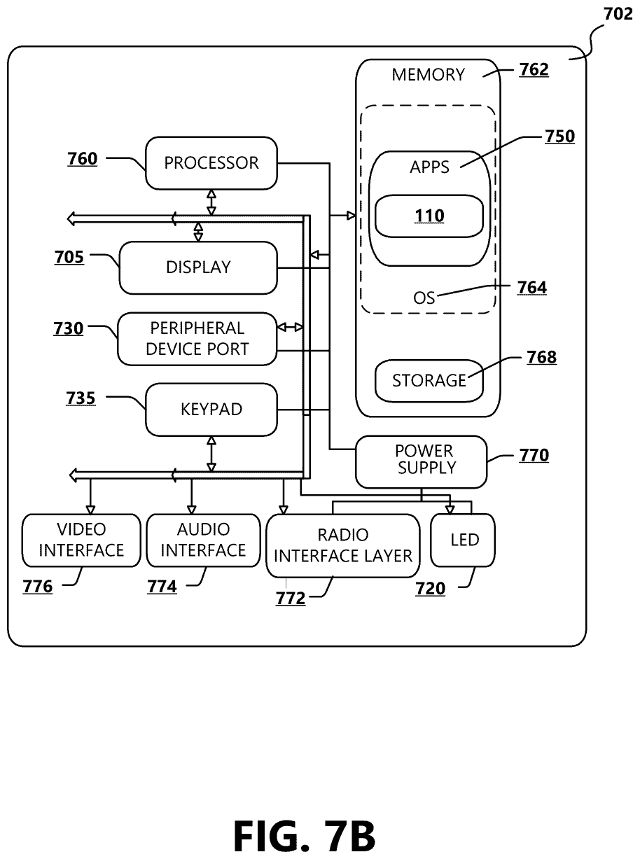

FIG. 1 is a block diagram illustrating an example system for inferring and alerting users about reduced availability according to examples. The example system 100 as presented is a combination of interdependent components that interact to form an integrated whole. Components of the system 100 may be hardware components or software components (e.g., applications, application programming interfaces (APIs), modules, virtual machines, or runtime libraries) implemented on and/or executed by hardware components of the system 100. In one example, components of systems disclosed herein are implemented on a single processing device. The processing device provides an operating environment for software components to execute and utilize resources or facilities of such a system. An example of processing device(s) comprising such an operating environment is depicted in FIGS. 6, 7A, and 7B. In another example, the components of systems disclosed herein are distributed across multiple processing devices. For instance, input may be entered on a client device and information may be processed on or accessed from other devices in a network, such as one or more remote cloud devices or web server devices.

In FIG. 1, the system 100 includes a plurality of client devices 102a-n (collectively, client devices 102), a client application 104 operating on the client devices 102, a network 114, a service environment 106, a calendar service 108, a reduced availability service 110, and other services 112. As can be appreciated, the scale and structure of systems, such as system 100 may vary and may include additional or fewer components than those described in FIG. 1. As one example, the service environment 106 and/or one or more services included in the service environment 106 may be incorporated into the client devices 102.

According to examples, the client devices 102 include at least one client device used by a target user. In examples, the target user uses a client application 104 operating on a client device 102 to utilize at least one calendar service 108 included in the service environment 106. The calendar service 108, for example, includes various calendar information that is provided to and evaluated by the reduced availability service 110 to determine whether the target user is working with reduced availability during a time range of interest. According to an example implementation, the client devices 102 further include at least one client device used by an end user. In examples, the end user uses a client application 104 operating on a client device 102 to receive a notification that the target user is working with reduced availability during the time range of interest.

According to examples, the client devices 102 detect and/or collect input data from one or more users or user devices. In some examples, the input data corresponds to user interaction with one or more software applications or services implemented by, or accessible to, the client devices 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of user activity corresponding to a task, a project, a data request, or the like. The input data may include, for example, audio input, touch input, text-based input, gesture input, and/or image input. The input data may be detected/collected using one or more sensor components of client device(s) 102. Examples of sensors include microphones, touch-based sensors, geolocation sensors, accelerometers, optical/magnetic sensors, gyroscopes, keyboards, and pointing/selection tools. Examples of client device(s) 102 include personal computers (PCs), mobile devices (e.g., smartphones, tablets, laptops, personal digital assistants (PDAs)), wearable devices (e.g., smart watches, smart eyewear, fitness trackers, smart clothing, body-mounted devices, head-mounted displays), and gaming consoles or devices, and Internet of Things (IoT) devices.

According to an example implementation, the client device(s) 102 provide the input data to the service environment 106 using network 114. Examples of the network 114 include a private area network (PAN), a local area network (LAN), a wide area network (WAN), and the like. Although the network 114 is depicted as a single network, it is contemplated that the network 114 may represent several networks of similar or varying types.

The service environment 106 provides the client device(s) 102 access to various computing services and resources (e.g., applications, devices, storage, processing power, networking, analytics, intelligence). As depicted in FIG. 1, the service environment 106 includes or provides access to the calendar service 108, the reduced availability service 110, and other services 112. In some example implementations, the service environment 106 is implemented in a cloud-based or server-based environment using one or more computing devices, such as server devices (e.g., web servers, file servers, application servers, database servers), edge computing devices (e.g., routers, switches, firewalls, multiplexers), personal computers (PCs), virtual devices, and mobile devices. Alternatively, the service environment 106 may be implemented in an on-premises environment (e.g., a home or an office) using such computing devices. The computing devices comprise one or more sensor components, as discussed with respect to the client device(s) 102. The service environment 106 may comprise numerous hardware and/or software components and may be subject to one or more distributed computing models/services (e.g., Infrastructure as a Service (IaaS), Platform as a Service (PaaS), Software as a Service (SaaS), Functions as a Service (FaaS)).

According to examples, the calendar service 108 includes an electronic calendar/schedule (herein generally referred to as a calendar) and tracks meetings or appointments, herein referred to as events, in a user's calendar. The calendar service 108 receives various information about upcoming events scheduled by or for the user and information about various settings associated with the user's calendar. For example, the calendar service 108 may receive information about an event that is to appear on the user's calendar and which the user plans or is expected to attend. This type of information is sometimes be referred to herein as calendar event information. In some examples, calendar event information may include, but is not limited to, information concerning: an event name; a subject matter of the event; a scheduled start time; a scheduled end time; an event date; an event location; a uniform resource locator (URL) associated with the event; a name of an organizer or sponsor of the event; a list of invited attendees; keynote speaker(s); an agenda; a schedule; other personalized messages; and the like.

In some examples, the calendar service 108 receives information about various settings associated with a target user's calendar. This type of information is sometimes be referred to herein as calendar settings information. For instance, various calendar settings information may include, but is limited to settings corresponding to working hours in a day, working days of a week, time zone, availability settings, and the like. In some examples, calendar settings information further includes settings corresponding to automatic reply messages (e.g., set by the target user for when they are out-of-office or unavailable to respond to messages).

According to examples, the reduced availability service 110 infers and notifies an end user about reduced working availability of a target user or a group of target users during a time range of interest. For instance, the reduced availability service 110 includes components for collecting calendar event information and calendar settings information corresponding to a calendar of a target user, generating an interval graph data structure based on the collected calendar information, determining working hours for the target user, identifying periods of time where reduced availability is determined in the target user's calendar, and determining and generating a notification of the target user's reduced availability for alerting the end user.

In some examples, the calendar service 108 and/or the reduced availability service 110 are integrated into (e.g., hosted by or installed in) the service environment 106. Alternatively, one or both of the calendar service 108 and/or the reduced availability service 110 are implemented externally to service environment 106. For instance, one or more of the calendar service 108 and/or the reduced availability service 110 may be implemented in a service environment separate from the service environment 106 or in client device(s) 102. In some examples, the system 100 includes a plurality of calendar services 108 used by the target users, wherein the plurality of calendar services 108 may operate in separate service environments.

According to an example implementation, the service environment 106 may provide access to other software and/or hardware functionality (e.g., other services 112), such as virtual meeting services, topic detection and/or classification services, data domain taxonomy services, expertise assessment services, content detection services, audio signal processing services, word processing services, spreadsheet services, presentation services, document-reader services, social media software or platforms, search engine services, media software or platforms, multimedia player services, content design software or tools, database software or tools, provisioning services, and alert or notification services.

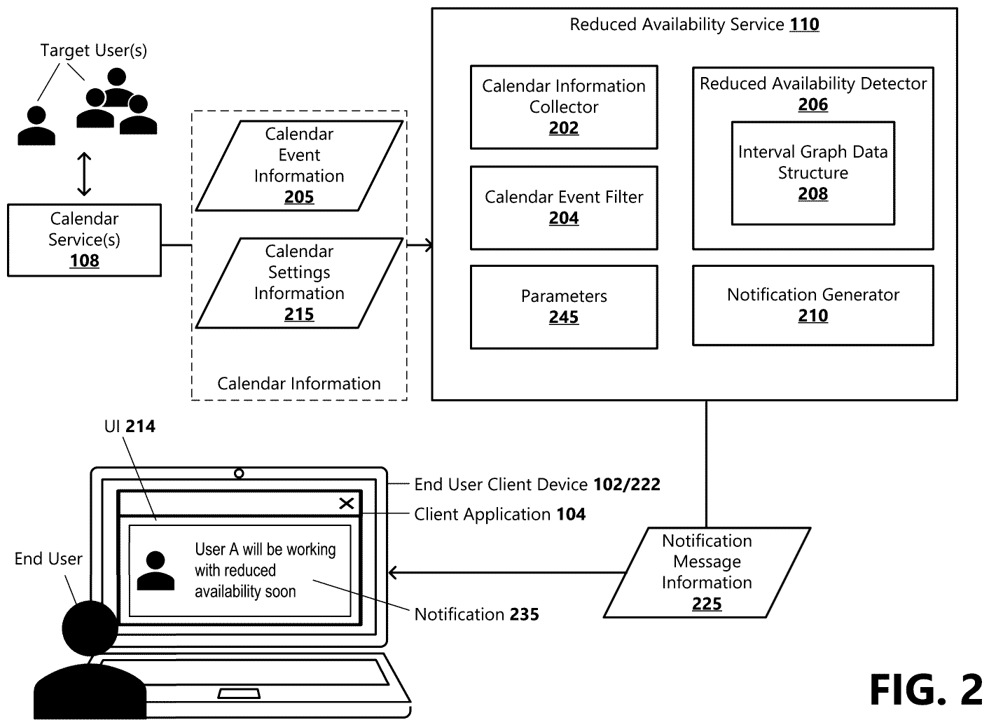

FIG. 2 illustrates a reduced availability service 110 for inferring and alerting users about reduced working availability according to an example implementation. In some examples, one or more components described in FIG. 2 (or the functionality thereof) are distributed across multiple devices or computing systems in one or more computing environments. In other examples, a single device comprises the components described in FIG. 2. In the example depicted in FIG. 2, the reduced availability service 110 includes a calendar information collector 202, a calendar event filter 204, various parameters 245, a reduced availability detector 206, and a notification generator 210.

The calendar information collector 202 receives various calendar information (e.g., calendar event information 205 and calendar settings information 215) of a target user or a group of target users. According to examples, the calendar information collector 202 requests the various calendar information from the calendar service(s) 108 used by a target user. In an example, the calendar information collector 202 requests calendar information corresponding to an upcoming time range of interest (e.g., a next day, a next several days, a next week, a next month, next year). The time range of interest is based on a scan-range parameter. For instance, the various parameters 245 depicted in FIG. 2 include the scan-range parameter. In some examples, the scan-range parameter is predefined. In some examples, the scan-range parameter is configurable. For instance, the end user of a client device 102 (e.g., end user client device 222) may be provided with an option (e.g., by a client application 104 operating on the end user client device 222) to select a time range of interest (e.g., one day, multiple days, a week, multiple weeks, a month, a year), which is then communicated to the reduced availability service 110. The time range of interest, for example, is a time range in the target user's calendar to be scanned for identifying intervals of time in which the target user is working with reduced availability. In some examples, the calendar information collector 202 requests additional calendar information for the time range of interest from additional services 112.

In some examples, the client application 104 defines the scan-range parameter based on a use case of the client application 104. For instance, if the client application 104 is a client application of the calendar service 108, the end user may use the client application 104 to schedule an upcoming meeting. A date associated with the upcoming meeting may be used to define the time range of interest, and thus, included in the scan-range parameter within which to scan for reduced availability. As another example, if the client application 104 is a client application of a social feed service, the scan-range parameter may be preset by the client application 104 or social feed service to display status updates or other notifications associated with a time range of interest. In some examples, the client application 104 or social feed service allows the end user to select the time range of interest, and thus, configure the scan-range parameter.

According to examples, calendar event information 205 includes various metadata associated with events included in the target user's calendar. Example metadata associated with calendar events include the event name, the subject matter, the scheduled start time, the scheduled end time, the event date, the event location, attached links, the name of an organizer or sponsor of the event, invited attendees, and the like. According to examples, the target user may have notice of and an opportunity to provide or deny consent to types of calendar event metadata that are shared with the reduced availability service 110.

In some example implementations, an “unavailable” tag is selectively applied to a calendar event and is included in calendar event metadata. For instance, an option to set a calendar event as “unavailable” may be provided in association with a calendar event (e.g., provided by the calendar service 108) or may be automatically applied based on one or more calendar event attributes (e.g., subject, duration, location, priority level, or other attribute of the calendar event). In some examples, setting a calendar event to “unavailable” indicates to the reduced availability service 110 that the target user is not available for another activity (e.g., work task) during the time interval of the “unavailable” calendar event. In other examples, other tags may be used, such as an “out-of-office” or “OOF” tag to indicate, for a time interval, that the target user is not available for another activity (e.g., work task) during the time interval.

In some examples, calendar settings information 215 includes working hours settings metadata, such as a time zone from which the target user is working, days-of-the-week on which the target user is working, days-of-the-month on which the target user is working, and a start and end time for each day on which the target user is working. In some examples, one or a combination of the working hours settings metadata is manually defined by the target user. For instance, the calendar service 108 from which the calendar information collector 202 is receiving the calendar settings information 215 may provide an option for enabling the target user to specify a time zone or to allow the client device 102 to determine the time zone of the target user based on geolocation data. The specified or determined time zone, for example, may be requested and received by the calendar information collector 202. Likewise, in some examples, the calendar service 108 may provide an option for enabling target users to specify their working days, working hours, and start/end times, which then may be requested and received by the calendar information collector 202. In other examples, the target user's working days, working hours, and start/end times are automatically inferred by the reduced availability service 110, for instance, based on past events in the target user's calendar.

In some examples, calendar settings information 215 includes automatic reply settings metadata. For instance, when the target user is unable to respond to emails or is otherwise busy, the target user may select to turn on an automatic reply feature provided by the calendar service 108 or another service in communication with the reduced availability service 110. Turning on the automatic reply feature allows the target user to select a start date/time and end date/time for an automatic reply, which are included in automatic reply settings metadata provided to the calendar information collector 202.

According to examples, the reduced availability detector 206 generates and/or accesses an interval graph data structure 208 that is used to rapidly scan through vast amounts of data with minimal runtime cost for identifying time intervals of reduced availability corresponding to a target user. The interval graph data structure 208 includes a timeline axis representing a selected or determined time range of interest. As described above, the time range of interest is based on a predetermined or configured scan-range parameter. In some examples, the reduced availability detector 206 generates a single interval graph data structure 208 for the time range of interest. In other examples, the reduced availability detector 206 generates a plurality of interval graph data structures 208 representing the time range of interest (e.g., an interval graph data structure 208 for each day of a multi-day time range of interest).

The reduced availability detector 206 further simulates calendaring constraints in real-time by overlaying various received calendar information onto the interval graph data structure 208. According to an example implementation, when the received calendar information includes automatic reply settings metadata, the reduced availability detector 206 overlays the automatic reply settings metadata (e.g., start and end times of an automatic reply) onto the interval graph data structure 208.

According to an example implementation, the reduced availability detector 206 further overlays calendar event information 205 onto the interval graph data structure 208. In some examples, prior to overlaying calendar event information 205 onto the interval graph data structure 208, the calendar event information 205 is filtered based on preset or selectable criteria. In an example implementation, the reduced availability service 110 uses the calendar event filter 204 to filter calendar event information 205 according to whether the associated calendar event is set to “OOF” (e.g., includes an “OOF” tag). According to another example, the reduced availability service 110 filters calendar event information 205 based on one or a combination of other calendar event metadata (e.g., an event category/type, event name, subject matter, event location, the name of an organizer or sponsor of the event, invited attendees). In some examples, the types of calendar event metadata that are used to filter the calendar event information 205 are defined in the parameters 245. For instance, these types of parameters 245 are sometimes referred to herein as filter parameters.

The reduced availability detector 206 further overlays filtered calendar event information 205 onto the interval graph data structure 208. Further, the reduced availability detector 206 determines working hours for the target user for the time range of interest and overlays the determined working hours onto the interval graph data structure 208. In some examples, the determined working hours are based on working days, working hours, and start/end times specified by the target user. In other examples, the reduced availability detector 206 infers the target user's working days, working hours, and start/end times based on past events in the target user's calendar.

In some example implementations, the reduced availability detector 206 scans the interval graph data structure 208 to identify free time intervals. A free time interval is an interval in the working hours of the target user where filtered calendar event information 205 and/or calendar settings information 215 are not overlaid onto the interval graph data structure 208. The term “calendaring conflict” is sometimes used herein to describe intervals where calendar event information 205 and/or calendar settings information 215 are overlaid onto the interval graph structure 208 and overlapping the target user's working hours and the time range of interest. For instance, one or more calendaring conflicts and the target user's working hours within the time range of interest define one or more free time intervals. That is, a free time interval may be identified within the working hours of the target user when the target user does not have a calendaring conflict, such as at least a portion of a scheduled event or a scheduled automatic reply time interval.

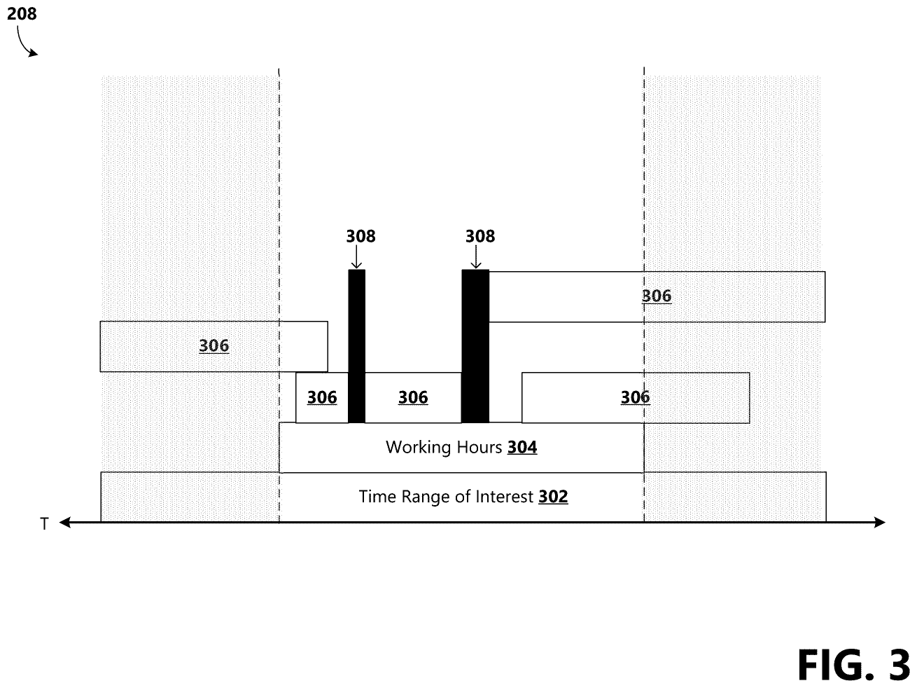

With reference now to FIG. 3, an example interval graph data structure 208 is depicted. As shown, a time range of interest 302 is defined along a time axis T of the interval graph data structure 208. Additionally, a plurality of calendaring conflicts 306 corresponding to filtered calendar event information 205 and/or calendar settings information 215 are overlaid onto the example interval graph data structure 208 along the time axis T. Additionally, the target user's working hours 304 are determined and overlaid along the time axis T in the example interval graph data structure 208. One or more free time intervals 308 occur and are identified when a calendaring conflict 306, such as a scheduled event or scheduled automatic reply, is not overlapping the working hours 304 and time range of interest 302. As mentioned above, in some examples, the client application 104 may be implemented as a calendar service 108, and a time and/or date associated with an upcoming meeting that the end user or another event organizer is scheduling is included in the scan-range parameter for defining the time range of interest within which to scan for reduced availability. Thus, in this example, the interval graph data structure 208 is scanned for a calendaring conflict that overlaps the time and/or date of the upcoming meeting. As another example, when the client application 104 is implemented as a social feed service that proactively presents information about reduced availability to an end user, a time range of interest may be scanned for a calendaring conflict that overlaps the working hours 304 and time range of interest 302.

According to an example, the reduced availability detector 206 further evaluates identified free time intervals 308. According to an example implementation, the reduced availability detector 206 determines whether one or a combination of identified free time intervals 308 meet a minimum availability threshold parameter. When one or a combination of identified free time intervals 308 do not meet the minimum availability threshold parameter, the reduced availability detector 206 determines the target user is working with reduced availability during the time range of interest 302.

According to another example implementation, the reduced availability detector 206 scans the interval graph data structure 208 to identify calendaring conflicts 306 in the working hours 304 of the target user that exceed a maximum availability threshold parameter. For instance, one or a combination of filtered calendar event information 205 and/or calendar settings information 215 overlaid onto the interval graph data structure 208 may exceed a defined maximum availability threshold parameter, where the maximum availability threshold parameter may be a defined ratio of the target user's working hours 304, for example. In other words, the calendaring conflicts 306 cause free time intervals 308 defined by the calendaring conflicts 306 to not meet the minimum availability threshold parameter. Thus, the reduced availability detector 206 determines the target user is working with reduced availability during the time range of interest 302.

In some examples, and with reference again to FIG. 2, when a determination is made that the target user is working with reduced availability during the time range of interest 302, the notification generator 210 determines whether to notify the end user about the target user's reduced availability. In an example implementation, the determination is based on one or more ranking criteria. Non-limiting examples of ranking criteria include a duration of the calendaring conflict 306 (e.g., a calendaring conflict with a longer duration is ranked higher than a shorter duration calendaring conflict), an event category/type of the calendaring conflict 306, and a social proximity between the end user and the target user (e.g., a social distance/proximity between users who are more collaborative is ranked higher than a less collaborative relationship).

As an example, ranking based on social proximity between the end user and the target user assigns a higher ranking to a target user who the end user collaborates with frequently or regularly and/or has a close connection within an organizational relationship diagram (e.g., the end user's manager) than a target user who the end user collaborates with infrequently and/or is not closely connected with in the organizational relationship. Collaboration with a target user, for example, may include sharing documents, communication, attending the same events, or other interactions shared amongst members of a team or organization.

According to examples, calendar event metadata associated with a calendaring conflict 306 that causes a target user to have reduced availability is evaluated by the notification generator 210, which then ranks the calendaring conflict 306 based on one or a combination of ranking criteria. In some examples, a notification 235 about the calendaring conflict 306 is provided to the end user when the calendaring conflict 306 meets a predetermined ranking threshold (e.g., a minimum score) or when the calendaring conflict 306 is one of a top N ranked calendaring conflicts 306.

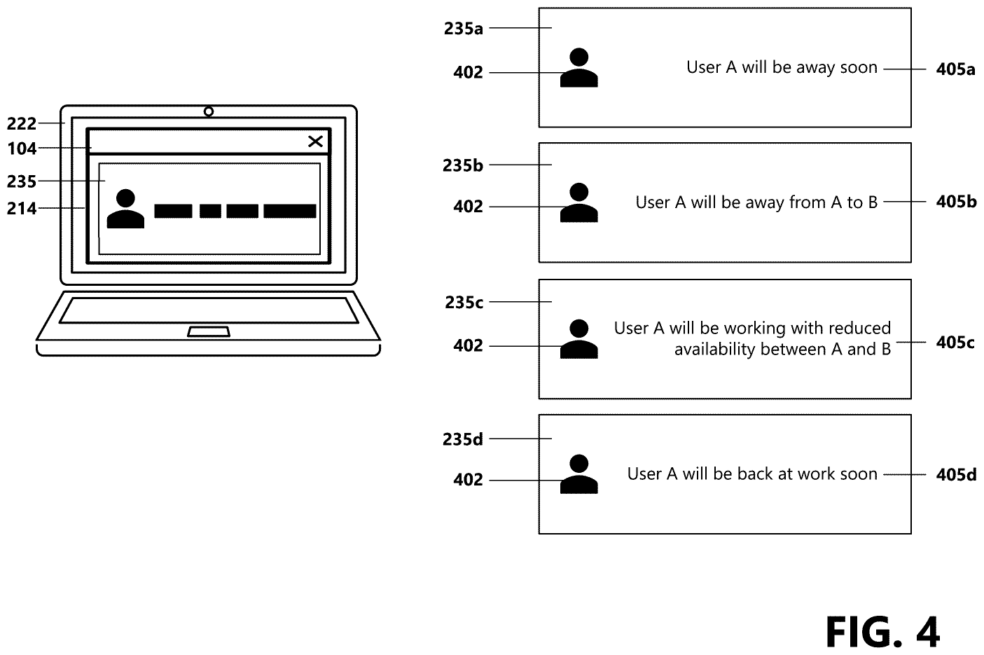

In some examples, the notification generator 210 determines a notification message for the notification 235 and provides notification message information 225 corresponding to the notification message to the client application 104 operating on the end user client device 222. According to examples, a notification 235 about a target user's reduced availability is presented to the end user via a user interface (UI) 214. The UI 214 may be a graphical UI (GUI), an audible UI, or other type of UI operative to present information to the end user. With reference now to FIG. 4, various example notifications 235a-d (collectively, notifications 235) are illustrated. For instance, each example notification 235 includes a notification message 405a-d (collectively, notification message 405) that informs the end user about the target user's reduced availability. In some examples, the notification 235 includes an avatar 402 or other identifier representative of the target user.

In some examples, the notification message 405 is selected based on a duration of identified free time intervals 308 within the working hours 304 of the target user. For instance, the duration of identified free time intervals 308 can indicate whether the target user has reduced availability for an entire working day, for most of the working day (e.g., during working hours 304 of the target user), for a portion of the working day, etc. The target user's working day, for example, is based on the determined working hours 304 of the target user. In one example, a notification message 405 stating that the target user “will be away” (e.g., notification messages 405a, 405b) is selected to inform the end user that the target user has calendaring conflicts 306 that cause the target user to be unavailable for an entire working day. In another example, a notification message 405 stating that the target user “will be working with reduced availability” (e.g., notification message 405c) is selected to inform the end user that the target user has calendaring conflicts 306 that cause the target user to be unavailable for most of a working day. In some examples, the message of a notification 235 further includes the interval of time associated with the calendaring conflict(s) 306 that cause the target user to be unavailable. For instance, a notification message 405 may state that the target user “will be away from ‘A’ to ‘B’” (e.g., notification message 405b) or “will be working with reduced availability between ‘A’ and ‘B’” (e.g., notification message 405c), where “A” is the start time or date of the calendaring conflict 306 and “B” is the end time or date of the calendaring conflict 306. In some examples, the message of a notification 235 informs the end user when a calendaring conflict 306 that causes the target user to have reduced availability or be unavailable will end. For instance, a notification message may state that the target user “will be back at work soon” (e.g., notification message 405d) or “will be back at work at/on “C””, where “C” is a beginning of a next free time interval 308. In further examples, the message of a notification 235 includes information about a calendaring conflict 306 that causes the target user to have reduced availability or to be unavailable. For instance, a notification message 405 may state that the target user “is attending ‘XYZ’ meeting”, where “XYZ” meeting is a subject of an event in the target user's calendar. In some example implementations, the notification generator 210 includes, in the notification message information 225 provided to the client application 104, a list of intervals (e.g., free time intervals and/or intervals of calendaring conflicts 306) and the client application 104 generates a notification message 405 based on the received notification message information 225. Other types of notification messages 405 are possible and are within the scope of the present disclosure.

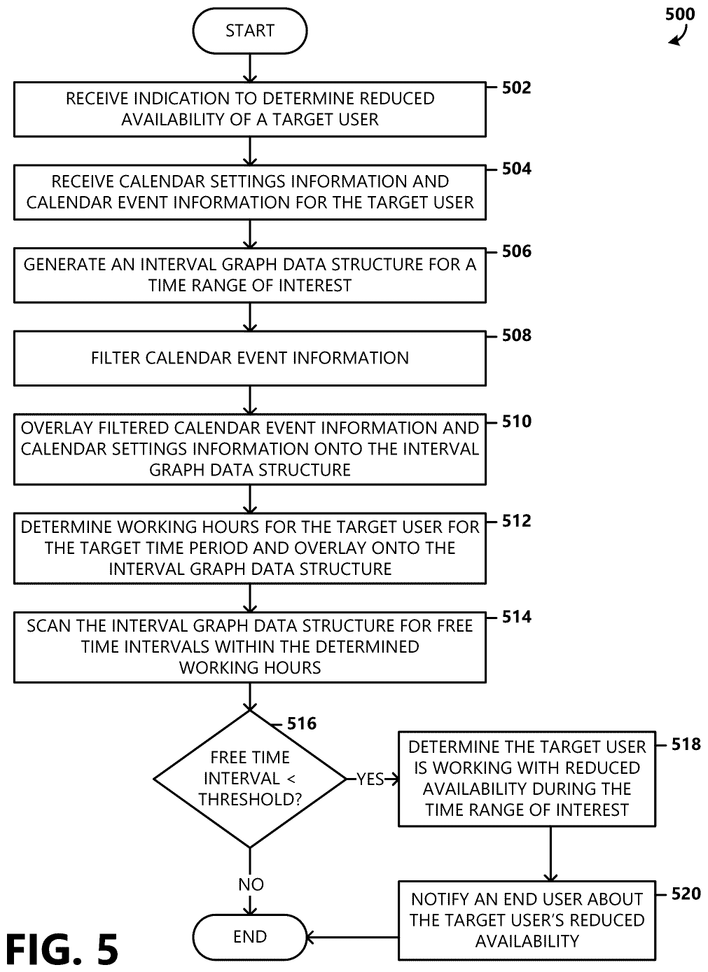

FIG. 5 is a flowchart depicting a method 500 for inferring and notifying about reduced availability of a user a group of users according to an example. With reference now to FIG. 5, the method 500 starts at operation 502 when an indication to determine reduced availability of a target user or a group of target users is received by the reduced availability service 110. In some examples, the indication is a request sent by a client application 104 operating on an end user's client device 222. As an example, the client application 104 is implemented as a client application of a social feed service that displays status updates (e.g., as a notification 235) about items of relevance to the end user in association with a time range of interest 302 (e.g., current day, a non-current day, several days, a week, a month, a year). The time range of interest 302, in some examples, is selectable, where a selected or preset time range of interest is communicated to the reduced availability service 110. As another example, the client application 104 is implemented as a client application of a calendar service 108 that provides notifications 235 about upcoming or potential calendaring conflicts. In some examples, the target user or group of target users are selected by the end user (e.g., explicit inquiry) or are selected in association with a task performed by the end user (e.g., implicit inquiry). In other examples, the target user or group of target users are preselected based on a group or team to which the end user is assigned.

At operation 504, various calendar information is received. For example, the calendar information collector 202 of the reduced availability service 110 collects or otherwise receives calendar event information 205 and calendar settings information 215 from at least one calendar service 108 used by each target user.

At operation 506, an interval graph data structure 208 is generated for the time range of interest 302. In some examples, a plurality of interval graph data structures 208 are generated for the time range of interest 302.

At operation 508, the calendar event information 205 is filtered based on a set of parameters 245 (e.g., filter parameters). For instance, the calendar event filter 204 is used to filter the received calendar event information 205 based on one or a combination of calendar event metadata, such as an “OOF” tag, an event category/type, event name, subject matter, event location, the name of an organizer or sponsor of the event, invited attendees, or the like.

At operation 510, the filtered calendar event information 205 and received calendar settings information 215 are overlaid onto the graph data structure 208. For instance, the reduced availability detector 206 overlays filtered calendar event information 205 and calendar settings information 215 corresponding to the time range of interest 302 onto the graph data structure 208.

At operation 512 working hours 304 for the target user for the time range of interest 302 are determined and overlaid onto the interval graph data structure 208. In some examples, the reduced availability detector 206 determines the working hours 304 based on working days, working hours, and start/end times specified by the target user or infers the target user's working days, working hours, and start/end times based on past events in the target user's calendar.

At operation 514, the interval graph data structure 208 is scanned for free time intervals 308 within the determined working hours 304 for the time range of interest 302.

At decision operation 516, a determination is made as to whether one or a combination of free time intervals 308 meet a minimum availability threshold parameter. When all time intervals meet the threshold, a determination is made that the user is not working with reduced availability and process ends. Alternatively, when a determination is made that one or more identified free time intervals 308 do not meet the minimum availability threshold parameter (e.g., the one or more identified free time intervals 308 are less than the minimum availability threshold parameter), the method 500 proceeds to operation 518, where a determination is made that the target user is working with reduced availability during the time range of interest 302.

At operation 520, a determination is made to notify the end user about the target user's reduced availability. The determination, for example, is based on various factors that the notification generator 210 is configured to evaluate, such as a social distance or proximity of the target user to the end user, a duration of the calendaring conflict 306 corresponding to the target user's reduced availability, or other factor. In some examples, calendar event metadata associated with a calendaring conflict 306 that causes a target user to have reduced availability is evaluated by the notification generator 210, which then ranks the calendaring conflict 306 based on one or a combination of ranking criteria. In some examples, a notification 235 about the calendaring conflict 306 is provided to the end user when the calendaring conflict 306 meets a predetermined ranking threshold (e.g., a minimum score) or when the calendaring conflict 306 is one of a top N ranked calendaring conflicts 306. In some examples, the notification generator 210 determines a notification message 405 for the notification 235 and provides notification message information 225 corresponding to the notification message to the client application 104 operating on the end user client device 222. According to examples, a notification 235 including a determined notification message 405 about a target user's reduced availability is presented to the end user via a UI 214.

FIGS. 6, 7A, and 7B and the associated descriptions provide a discussion of a variety of operating environments in which examples of the disclosure may be practiced. However, the devices and systems illustrated and discussed with respect to FIGS. 6, 7A, and 7B are for purposes of example and illustration, a vast number of computing device configurations that may be utilized for practicing aspects of the disclosure, described herein.

FIG. 6 is a block diagram illustrating physical components (e.g., hardware) of a computing device 600 with which examples of the present disclosure may be practiced. The computing device components described below may be suitable for one or more of the components of the system 100 described above. In a basic configuration, the computing device 600 includes at least one processing unit 602 and a system memory 604. Depending on the configuration and type of computing device 600, the system memory 604 may comprise volatile storage (e.g., random access memory), non-volatile storage (e.g., read-only memory), flash memory, or any combination of such memories. The system memory 604 may include an operating system 605 and one or more program modules 606 suitable for running software applications 650, such as the reduced availability service 110, the client application 104, and other applications.

The operating system 605 may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including one or more of the stages of method 500 illustrated in FIG. 5. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing spatial-textual clustering-based predictive recognition of text in a video may be operated via application-specific logic integrated with other components of the computing device 600 on the single integrated circuit (chip). Examples of the present disclosure may also be practiced using other technologies capable of performing logical operations such as, for example, AND, OR, and NOT, including mechanical, optical, fluidic, and quantum technologies.

The computing device 600 may also have one or more input device(s) 612 such as a keyboard, a mouse, a pen, a sound input device, a touch input device, a camera, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 604, the removable storage device 609, and the non-removable storage device 610 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer readable media may be part of the computing device 600. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

FIGS. 7A and 7B illustrate a mobile computing device 700, for example, a mobile telephone, a smart phone, a tablet personal computer, a laptop computer, and the like, with which aspects of the disclosure may be practiced. With reference to FIG. 7A, an example of a mobile computing device 700 for implementing at least some aspects of the present technology is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative examples, mobile computing device 700 may incorporate more or less input elements. For example, the display 705 may not be a touch screen in some examples. In alternative examples, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 can incorporate a system (e.g., an architecture) 702 to implement some examples. In one example, the system 702 is implemented as a “smart phone” capable of running one or more applications (e.g., videoconference or virtual meeting application, browser, e-mail, calendaring, contact managers, messaging clients, games, and media clients/players). In some examples, the system 702 is integrated as a computing device, such as an integrated personal digital assistant (PDA) and wireless phone.

One or more application programs 750 (e.g., one or more of the components of system 100) may be loaded into the memory 762 and run on or in association with the operating system 764, such as the client application 104 or the reduced availability service 110. Other examples of the application programs 750 include videoconference or virtual meeting programs, phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at a remote device or server. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency (RF) communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

The visual indicator 720 (e.g., light emitting diode (LED)) may be used to provide visual notifications and/or an audio interface 774 may be used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. The system 702 may further include a video interface 776 that enables an operation of a peripheral device port 730 (e.g., an on-board camera) to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

Examples include a computer-implemented method, comprising: receiving calendar information for a time range of interest for a target user; generating an interval graph data structure for the time range of interest; overlaying the calendar information onto the interval graph data structure; determining working hours for the target user; overlaying the determined working hours onto the interval graph data structure; scanning the interval graph data structure for a free time interval within the determined working hours; identifying at least one free time interval; determining the at least one free time interval is below an availability threshold; determining the target user is working with reduced availability in the time range of interest; and providing a notification about the reduced availability of the target user.

Examples include a system, the system comprising at least one processor; and memory storing instructions that, when executed by the at least one processor cause the system to: receive calendar information for a time range of interest for a target user; generate an interval graph data structure for the time range of interest; overlay the calendar information onto the interval graph data structure; determine working hours for the target user; overlay the determined working hours onto the interval graph data structure; scan the interval graph data structure for a free time interval within the determined working hours; identify at least one free time interval; determine the at least one free time interval is below an availability threshold; determine the target user is working with reduced availability in the time range of interest; and provide a notification about the reduced availability of the target user.

Examples include a computer-readable medium storing instructions that, when executed by a computer, cause the computer to: receive calendar event information and calendar settings information for a time range of interest for a target user; generate an interval graph data structure for the time range of interest; filter the calendar event information based on one or a combination of calendar event metadata; overlay the filtered calendar event information and the calendar settings information onto the interval graph data structure; determine working hours for the target user; overlay the determined working hours onto the interval graph data structure; scan the interval graph data structure for a free time interval within the determined working hours; identify at least one free time interval; determine the at least one free time interval is below an availability threshold; determine the target user is working with reduced availability in the time range of interest; and provide a notification about the reduced availability of the target user.

The methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

Furthermore, boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computer-implemented method, comprising:
receiving calendar information for a time range of interest for a target user;
generating an interval graph data structure for the time range of interest;
overlaying the calendar information onto the interval graph data structure;
determining working hours for the target user;
overlaying the determined working hours onto the interval graph data structure;
scanning the interval graph data structure for a free time interval within the determined working hours;
identifying at least one free time interval;
determining the at least one free time interval is below an availability threshold;
determining the target user is working with reduced availability in the time range of interest; and
providing a notification about the reduced availability of the target user.

2. The method of claim 1, wherein overlaying the received calendar information onto the interval graph data structure further comprises:
filtering the received calendar information based on one or a combination of calendar event metadata; and
overlaying the filtered calendar information onto the interval graph data structure.

3. The method of claim 2, wherein filtering the received calendar information based on one or a combination of calendar event metadata comprises filtering the received calendar information based on a tag indicating the target user is unavailable for another work task during a time interval.

4. The method of claim 1, wherein:
receiving calendar information for the time range of interest for the target user comprises:
receiving calendar event information; and
receiving calendar settings information; and
overlaying the calendar information onto the interval graph data structure comprises:
overlaying calendar event information; and
overlaying calendar settings information onto the interval graph data structure.

5. The method of claim 4, wherein overlaying calendar settings information onto the interval graph data structure comprises overlaying a start time and an end time of an automatic reply setting.

6. The method of claim 1, further comprising, prior to providing the notification:
ranking a calendaring conflict corresponding to the reduced availability of the target user based on one or a combination of ranking criteria;
determining the ranking of the calendaring conflict corresponding to the reduced availability of the target user meets a predetermined ranking threshold; and
determining to generate the notification.

7. The method of claim 6, wherein ranking the calendaring conflict corresponding to the reduced availability of the target user based on one or a combination of ranking criteria comprises:
ranking the calendaring conflict based on a duration of the calendaring conflict; or
ranking the calendaring conflict based on a social proximity of the target user and an end user to whom the notification is provided.

8. The method of claim 1, wherein providing the notification about the reduced availability of the target user comprises:
determining a notification message; and
providing the notification message for display in a user interface.

9. A system comprising:
at least one processor; and
memory storing instructions that, when executed by the at least one processor cause the system to:
receive calendar information for a time range of interest for a target user;
generate an interval graph data structure for the time range of interest;
overlay the calendar information onto the interval graph data structure;
determine working hours for the target user;
overlay the determined working hours onto the interval graph data structure;
scan the interval graph data structure for a free time interval within the determined working hours;
identify at least one free time interval;
determine the at least one free time interval is below an availability threshold;
determine the target user is working with reduced availability in the time range of interest; and
provide a notification about the reduced availability of the target user.

10. The system of claim 9, wherein in overlaying the received calendar information onto the interval graph data structure, the instructions cause the system to:
filter the received calendar information based on one or a combination of calendar event metadata; and
overlay the filtered calendar information onto the interval graph data structure.

11. The system of claim 10, wherein the one or a combination of calendar event metadata comprises a tag indicating the target user is unavailable for another work task during a time interval.

12. The system of claim 9, wherein the calendar information comprises:
calendar event information; and
calendar settings information.

13. The system of claim 12, wherein in overlaying the calendar information onto the interval graph data structure, the instructions cause the system to:
overlay the calendar event information onto the interval graph data structure; and
overlay the calendar settings information onto the interval graph data structure.

14. The system of claim 12, wherein overlaying calendar settings information onto the interval graph data structure, the instructions cause the system to overlay a start time and an end time of an automatic reply setting onto the interval graph data structure.

15. The system of claim 9, wherein, prior to providing the notification, the instructions further cause the system to:
rank a calendaring conflict corresponding to the reduced availability of the target user based on one or a combination of ranking criteria;
determine the ranking of the calendaring conflict corresponding to the reduced availability of the target user meets a predetermined ranking threshold; and
determine to generate the notification.

16. The system of claim 15, where in ranking the calendaring conflict corresponding to the reduced availability of the target user based on one or a combination of ranking criteria, the instructions cause the system to:
rank the calendaring conflict based on a duration of the calendaring conflict; or
rank the calendaring conflict based on a social proximity of the target user and an end user to whom the notification is provided.

17. The system of claim 9, wherein in providing the notification about the reduced availability of the target user, the instructions cause the system to:
determine a notification message; and
provide the notification message for display in a user interface.

18. A computer-readable medium storing instructions that, when executed by a computer, cause the computer to:
receive calendar event information and calendar settings information for a time range of interest for a target user;
generate an interval graph data structure for the time range of interest;
filter the calendar event information based on one or a combination of calendar event metadata;
overlay the filtered calendar event information and the calendar settings information onto the interval graph data structure;
determine working hours for the target user;
overlay the determined working hours onto the interval graph data structure;
scan the interval graph data structure for a free time interval within the determined working hours;
identify at least one free time interval;
determine the at least one free time interval is below an availability threshold;
determine the target user is working with reduced availability in the time range of interest; and
provide a notification about the reduced availability of the target user.

19. The computer-readable medium of claim 18, wherein in overlaying calendar settings information onto the interval graph data structure, the instructions cause the computer to overlay a start time and an end time of an automatic reply setting onto the interval graph data structure.

20. The computer-readable medium of claim 18, wherein, prior to providing the notification, the instructions further cause the computer to:
rank a calendaring conflict corresponding to the reduced availability of the target user based on one or a combination of ranking criteria;
determine the ranking of the calendaring conflict corresponding to the reduced availability of the target user meets a predetermined ranking threshold; and
determine to generate the notification.
